(19) United States
(12) Patent Application Publication
(10) Pub. No.: US 2002/0092234 A1
(43) Pub. Date: Jul. 18, 2002

(54) Universal flame safety apparatus

(76) Inventors: Tracy D. Staller, Knoxville, TN (US); Larry E. Campbell, Knoxville, TN (US)

Correspondence Address: KENNETH H. JOHNSON, P.O. Box 630708, HOUSTON, TX, 77263, US

(21) Appl. No.: 09/727,077

(22) Filed: Nov. 30, 2000

Related U.S. Application Data
(60) Provisional application No. 60/168,319, filed on Dec. 1, 1999.

(51) Int. Cl. F17D 3/00

(52) U.S. Cl. 48/192

(57) ABSTRACT

An apparatus for arresting and extinguishing a flame having a flame arrestor, a lid aligned with the flame arrestor and adapted to move into contact with said flame arrestor to extinguish said flame, when a member which holds the lid away from the frame arrestor the is destroyed by the flame as it reaches the surface of the flame arrestor. In order to obtain this operation the member is made on a material that is destroyed at about the temperature of the flame, for example by melting.

### BACKGROUND OF THE INVENTION

1. Field of the Invention

Heaters powered by combustion, especially those with standing pilot lights, and electrical devices with hot spots or sparks pose serious fire hazards if exposed to flammable solvents or their vapors. This presents a more serious problem when this equipment is installed in garages or utility rooms or industrial sites where solvents, gasoline or other combustible compounds may be used or stored.

A buildup of flammable vapors could infiltrate the combustion chamber of a heater or an electrical component such as a switch where ignition would occur if vapor builds to flammable limits. The flame could then travel to the source of the vapor and ignite or explode.

U.S. Pat. Nos. 5,144,360 and 5,211,554 issued to Robert Rajewski describe a flame arrestor which uses ceramic beads and stainless steel balls to quench the flame and relies on heat transfer to the ceramic media to reduce the temperature of the flame front. When enough heat has been transferred to the media, it loses its effectiveness. The inventor states that this flame arrestor can function for hours. U.S. Pat. No. 5,415,233 issued to Nicholas Roussakis et al describes a composite device which acts in a conventional way using wire mesh and crimped and corrugated metal but also includes special turbulent inducing vanes and structures to quench detonation or deflagration flames when such events occur. This structure of necessity induces flow restriction, which would limit the scope of usefulness. This device is designed to contain flame fronts but does not permanently extinguish the flames. U.S. Pat. No. 5,375,565 issued to Maxson et al describes a spiral wound metal flame arrestor for the intake of an internal combustion engine.

U.S. Pat. No. 5,797,355 issued to Bourke, discloses a water heater design which can be used in the presence of combustible fumes. The water heater uses conventional flame arrestors coupled with gas shut off valves and flame sensing and oxygen sensing devices. This complex system may increase the cost of a water heater by 30 to 60%. Flame arrestors are effective barriers to flame movement. Most flame arrestors, however, do not extinguish the flames. Even though flames may be contained in the ignition chamber, the danger of overheating with subsequent damage and even explosion still exists.

A flame arrestor can be constructed in many configurations such as honeycomb structures or metal screens or perforated plates placed in a configuration between the ignition source and the air intake. In combustion applications it is essential that the flame arrestor not impede the flow of air, in order to maintain efficient and safe operation. In many electrical applications free flow of air is important for cooling.

The typical pilot light in a combustion chamber which heats a thermopile, to activate a safety and shut off a fuel valve. As long as the pilot is lit, the burner can cycle on and off in order to provide enough heat to satisfy a thermostat. The pilot light as well as the full flame can act to ignite flammable vapors. Indeed, the pilot light is a more serious problem because the low air draft velocity during pilot operation is insufficient to counteract the flame velocity moving toward the source of flammable substance.

A good flame arrestor prevents flames from moving upstream by a variety of techniques which are not limited to the following: (1) quenching to reduce the fuel air mixture temperature below ignition point, (2) eliminating turbulence which provides for oxygen depletion thus reducing flame velocity, (3) increasing draft velocity thus counteracting flame velocity. Regardless of the types of flame arrestor mechanism, the best case scenario is to contain the flame downstream of the flame arrestor.

It is an advantage of the present invented that it is an apparatus, which can be used in conjunction with any flame arrestor to extinguish, the combustion of the flammable vapors, the pilot light and normal fuel combustion. It is a further advantage that the present invention provides a means to supplement a flame arrestor to extinguish the combustion in a potential ignition chamber whether caused by flames, hot spots or sparks when flammable vapors build to dangerous concentrations.

### SUMMARY OF THE INVENTION

Briefly the present invention is an apparatus for arresting and extinguishing a flame comprising a flame arrestor, a lid aligned with said and adapted to move into contact with said flame arrestor to extinguish said flame, a member which is destructible at about the temperature of said flame, said member being positioned to prevent said lid from contact with said flame arrestor until said member is destroyed.

The term “destroyed” as it used herein includes, material that melts, burns, vaporizes or in any manner is changed in form at or about the temperature of the flame to be extinguished, such that the member of which it is constructed is no longer a structural member capable of retaining the lid in place.

### BRIEF DESCRIPTION OF THE DRAWINGS

FIG. 1 is a schematic representation of an embodiment of the present invention using a spring biased lid.

FIG. 2 is a schematic representation of an embodiment of the present invention using a spring biased lid and an alternative form of destructible release.

FIG. 3 is a schematic representation of an embodiment of the present invention using a gravity operated lid.

FIG. 4 is a schematic representation of an embodiment of the present invention using a spring biased rod to draw the lid downward.

FIG. 5 is a schematic representation of an embodiment of the present invention using a weight loaded rod to draw the lid downward.

### DETAILED DESCRIPTION OF THE INVENTION

In one embodiment the present invention is an apparatus for arresting and then extinguishing a flame comprising a flame arrestor attached to a flame extinguishing device which comprises a non flammable lid or plate of equal or greater cross sectional area as the flame arrestor. The lid having a hole or holes to allow it to slide over a structural post or posts which are attached to the flame arrestor. The post(s)has a stop spacer at the top, to hold a compressed spring against the lid, and to provide a defined space between the lid and the surface of the flame arrestor. The lid to be held against the compressed spring by a bottom spacer which is constructed of flammable or low melting material. The flame arrestor and flame extinguishing device configured such that the lid and post are between the flame arrestor surface and the source of flames.

In another embodiment the present invention is an apparatus for arresting and then extinguishing a flame comprising a flame arrestor attached to a flame extinguishing device which comprises a non flammable lid or plate of equal or greater cross sectional area as the flame arrestor. The lid having a hole or holes to allow it to slide over a structural post or posts which are attached to the flame arrestor. The lid having sufficient weight to overcome friction and force the lid to fall. The lid to be held in place by a bottom spacer which is constructed of flammable or low melting material. The flame arrestor and flame extinguishing device are configured, such that the lid and post are between the flame arrestor surface and the source of flames and used in a vertical configuration.

In another embodiment the present invention is an apparatus for arresting and then extinguishing a flame comprising a flame arrestor attached to a flame extinguishing device which comprises a non flammable lid or plate of equal or greater cross sectional area as the flame arrestor. The lid being attached to the top of a post which is free to move through a sleeve, which in turn is attached to and penetrates the flame arrestor. The bottom of the post is attached to a stop spacer which compresses a spring against the bottom side of the flame arrestor. The spring is held in compression by a meltable spacer or pin, which is held against top of the flame arrestor. The flame arrestor and flame extinguishing device are configured, such that the lid is positioned between the flame and the surface of the flame arrestor.

In a further embodiment the present apparatus for arresting and then extinguishing a flame comprises a flame arrestor attached to a flame extinguishing device which comprises a nonflammable lid or plate of equal or greater cross sectional area as the flame arrestor. The lid being attached to the top of a post which is free to move through a sleeve, which in turn is attached to and penetrates the flame arrestor. The bottom of the post is attached to a weight of sufficient size to overcome the friction of the post failing through the sleeve. The lid is held in position to provide a space between the lid and the top surface of the flame arrestor by a meltable spacer or pin, which is held against top of the flame arrestor. The flame arrestor and flame extinguishing device configured such that the lid is positioned between the flame and the surface of the flame arrestor and must be used in a vertical position.

The flame arrestor may be a metal or ceramic honeycomb structure with 100 to 1300 cells per square inch or woven or knitted metal or ceramic screen or cloth. The post(s) and lid may be made of metal or ceramic or ceramic coated metal. The posts may be threaded into the core of a corrugated crimped metal honeycomb or may be made from corrugated crimped metal honeycomb.

The meltable spacers may be made from solders or brazing alloys or the spacer may be made from metal and is attached to the post with solder or brazing alloys. The spacers may be made of plastic or metal or plastic which is attached to the post with plastic adhesive. In order to improve the seal when the lid contacts the flame arrestor the lid may have a ceramic or fiber glass gasket on the bottom outer edge. In the drawings the same designations may be used for the same component in different FIGS.

Referring to FIG. 1 a schematic of the apparatus is shown. A metal post 10 is attached to the downstream face of the flame arrestor 12. A lid 14 made of nonflammable material preferably metal is fashioned to have a cross sectional area equal to or larger than the face of the flame arrestor. A hole (not shown) is cut in the lid to allow the lid to slide up and down on the structural post. The lid is pushed up the post to compress a spring 16 between the top of the lid and the head of the structural post 18. The lid is then secured in this position using a melt-able spacer 20 fixed to the post. The spacer is fabricated of flammable or low melting temperature material.

As flammable vapor increases in the fuel combustion chamber some is burned, the oxygen is depleted and the flame from the pilot or burner becomes larger, but lazier. As the vapor concentration continues to increase, the flame moves upstream toward the flame arrestor surface 22. As combustion becomes localized on the surface between the flame arrestor and the lid (also functioning as a shield) the thermopile which controls the pilot light cools and shuts off the burner assembly.

In an electrical device, fumes can build up to the flammable level and then be ignited by a spark. The flame will move toward the source of the fumes and will be halted by the surface of the flame arrestor.

Combustion of flammable vapors continues in the space between the flame arrestor and the lid (shield) until the spacer melts or is destroyed by combustion releasing the lid to fall against the surface of the flame arrestor, thus preventing the flow of flammable vapors and combustion air.

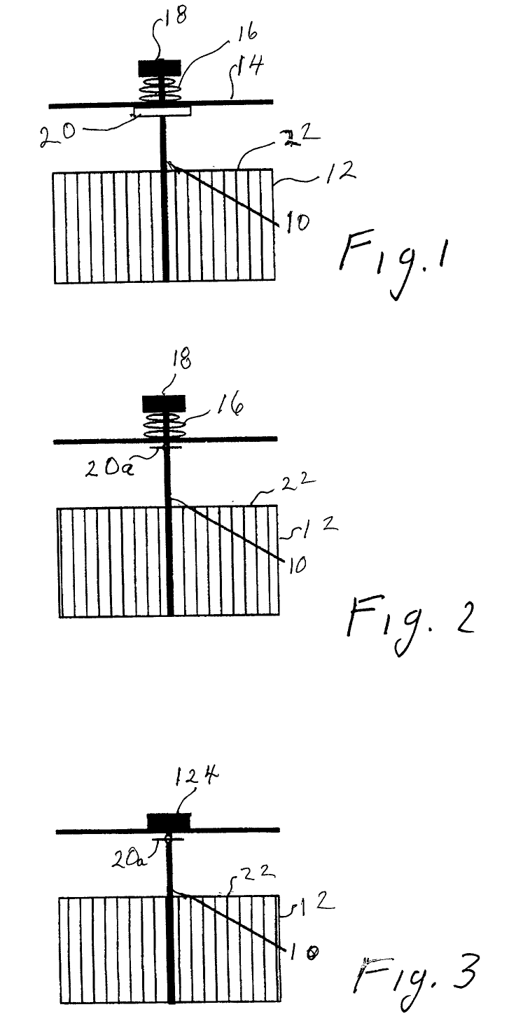

A variation of this principle is shown in FIG. 2 In this configuration the lid is held against the spring by a wire or pin 20a inserted in a hole (not shown) in the post. This configuration would be advantageous for a system where the flame arrestor could be reset. The pin could be replaced through the access port without disassembly of the combustion chamber.

Another variation is shown in FIG. 4. This configuration is used where it is advantageous to protect the spring assembly and where quick flame extinction is required. The pin or spacer 120 is placed directly on the surface 122 of the flame arrestor 112 and the spring is located upstream of the flame arrestor surface. An example of where this configuration would be useful would be where the flammable vapors produce corrosive combustion products, which might cause premature triggering of the device. The close proximity of the meltable pin or spacer to the flame arrestor surface would trigger the device at the first signs of flame on the arrestor surface. In this case the post 110 would move through a sleeve 130 in the flame arrestor. Upon destruction of the spacer the spring would bias the head 118 downward and draw the lid down onto the surface 122.

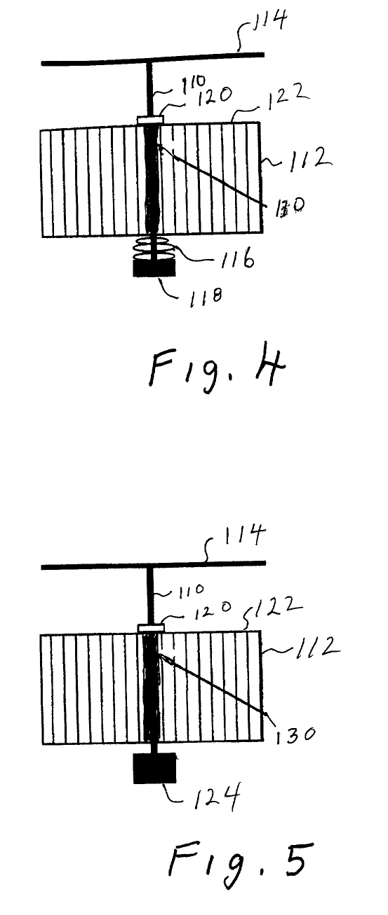

FIGS. 3 and 5 show a variation where the spring can be replaced by a weight 124 in FIGS. 2 and 4, respectively, for use in a vertical position.

### EXAMPLE 1

A 40,000 BTU/hour States Industries gas water heater was set up for experimentation. The exhaust of the water heater was sampled by a vacuum pump, which extracted one-third cubic foot/minute from the exhaust pipe. The gas sample was analyzed for carbon dioxide, oxygen, carbon monoxide and nitrogen oxide.

An 8 mm camcorder was used to visually monitor and record the burner assembly during the tests. A small hole was cut in the bottom of the water heater to accommodate a surveillance camera. A second hold was cut to allow the injection of propane to simulate solvent vapors. The propane was delivered using a mass flow transducer.

A 6-inch diameter stainless steel honeycomb with 150 cells per square inch and 2 inches deep was placed under the burner assembly. The only obstruction between the flame arrestor and flames was the gas delivery tube, which held the orifice and venturi and burner assembly.

The water heater was started by lighting the pilot light and turning on the heat. After 30 minutes the water heater stabilized and data was collected to establish a base line operating condition. From data collected and shown in Table 1 below the flow rate of combustion air was calculated. All the combustion air enters through the honeycomb. Propane was delivered at increments of 0.392 liters/minute and data was collected until the propane in air exceeded flammability limits.

TABLE I

| | | VOC, | CO | NOx | Temperature | Calculated |
|---|---|---|---|---|---|---|
| % O₂ | % CO₂ | ppm | ppm | ppm | ° F. Vent | Air Flow, scfm |
| 5.1 | 9.2 | 1.5 | 0.5 | 80 | 133 | 8.5 |

Visual observation of the flame showed that as the propane flow was increased, the flame from the natural gas burner grew larger and lazier. The exhaust was depleted of oxygen and the levels of hydrocarbons and carbon monoxide increased indicating incomplete combustion and the nitrogen oxide levels decreased indicating a cooler flame. The data was used to calculate the exhaust flow rate. The data is shown in Table 2 below:

TABLE 2
Exhaust Gas During Flash Back Study

| Propane scfm | % O₂ | % CO₂ | VOC, ppm | CO, ppm | NOx, ppm | Exhaust, scfm |
|---|---|---|---|---|---|---|
| 0.028 | 3.2 | 10.3 | 0 | 7.8 | 75 | 8.72 |
| 0.042 | 2.2 | 11.0 | 0 | 39.1 | 72 | 8.69 |
| 0.055 | 1.1 | 11.7 | 25 | 333 | 72 | 8.65 |
| 0.069 | 0.4 | 12.0 | 500 | 2563 | 70 | 8.64 |
| 0.083 | 0.1 | 11.9 | 1500 | 4994 | 66 | 8.62 |
| 0.097 | 0.0 | 11.7 | 3000 | 7529 | 66 | 8.64 |
| 0.111 | 0.0 | 11.7 | 5000 | 7792 | 35 | 8.64 |
| 0.118 | 0.0 | 11.6 | 6500 | 7743 | 10 | 8.62 |
| 0.125 | 0.0 | 11.6 | 8500 | 7735 | 5 | 8.59 |
| 0.131 | 0.0 | 11.5 | 8800 | 9191 | 4 | 8.61 |
| 0.138 | 0.0 | 11.7 | 10000 | 7114 | 1 | 8.61 |
| 0.152 | 0.0 | 11.3 | 20000 | 8622 | 0 | 7.63 |

As the propane concentrations got closer to the flammability limit (2% in air or 0.1 52 scfm), the flames migrated to the surface of the flame arrestor where they burned vigorously in pulsating fashion. The flames alternated from short and intensely yellow-white to tall and blue. The heat from these flames caused the burner assembly above them to glow red-white hot. The flames continued for 10 minutes before the experiment was terminated out of concern for damage to the orifice and burner. Although the flame arrestor prevented the flames from moving upstream to the flammable vapor source the flames did not extinguish and at no time during this experiment did the pilot light or the flames from the burner assembly extinguish.

### EXAMPLE 2

The same experiment was carried out as described in Example 1 with the following exceptions:

A 4″ post was prepared by milling a ¼″ bolt. A 6″ diameter stainless steel disc was made from 30 gauge metal sheet. A ¼″ hole was drilled in the center of the disc. An expanded spring was placed on the post followed by the 6″ disc. The disc was adjusted to compress the spring against the head of the post and nut made of solder was threaded onto the post to hold the plate in position.

This assembly shown in FIG. 1 was then positioned by pushing the bottom of the post through the center of the metal honeycomb.

The space between the bottom of the disc and the face of the flame arrestor was about ¾″. The fitted flame arrestor was positioned just under the water heater burner assembly. The water heater was lit and data gathered. The experimental data is shown in Table 3.

TABLE 3
Exhaust Gas Characterization During Flash Back

| Propane | | | | CO | Total | |
|---|---|---|---|---|---|---|
| scfm | O₂ | CO₂ | VOC, ppm | ppm | NOx ppm | Flow scfm |
| 0.042 | 2.0 | 11.3 | 0 | 35.6 | 55 | 8.50 |
| 01055 | 1.0 | 11.9 | 17 | 346 | 52 | 8.53 |
| 0.069 | 0.4 | 12.2 | 250 | 1992 | 50 | 8.61 |
| 0.083 | 0.0 | 12.1 | 1500 | 5452 | 42 | 8.62 |
| 0.111 | 0.0 | 11.4 | 6500 | 10648 | 10 | 8.53 |
| 0.125 | 0.0 | 11.2 | 10000 | 9561 | 10 | 8.42 |
| 0.131 | 0.0 | 11.0 | 10000 | 10400 | 5 | 8.63 |
| 0.138 | 0.0 | 11.4 | 30000 | 5000 | 0 | 6.46 |

Visual observations of the flame showed similar flame expansion and movement to the surface of the flame arrestor. As the propane concentrations reach flammability (2%) the flame again concentrated on the surface of the flame arrestor. The disc shielded the thermopile from the flame and the pilot light and the natural gas combustion ceased. The flames continued dancing on the surface of the flame arrestor until the solder spacer melted at which time the spring forced the disc against the flame arrestor surface and the flames extinguished.

The invention claimed is:

1. An apparatus for arresting and extinguishing a flame comprising a flame arrestor, a lid aligned with said and adapted to move into contact with said flame arrestor to extinguish said flame, a member which is destructible at about the temperature of said flame, said member being positioned to prevent said lid from contact with said flame arrestor until said member is destroyed.

2. The apparatus according to claim 1 wherein said lid is biased toward said flame arrestor by a spring.

3. The apparatus according to claim 1 wherein said lid is biased toward said flame arrestor by gravity.

4. The apparatus according to claim 1 wherein said member is meltable.

5. The apparatus according to claim 1 wherein said member is flammable.

6. The apparatus according to claim 1 wherein said lid is positioned on a post and aligned with said flame arrestor.

7. The apparatus according to claim 6 wherein said post passes into said flame arrestor.

8. The apparatus according to claim 6 wherein said post passes through said flame arrestor.

9. The apparatus according to claim 7 wherein said lid is biased by a spring.

10. The apparatus according to claim 7 wherein said lid is biased by a weight.

11. The apparatus according to claim 8 wherein said lid is biased by a spring.

12. The apparatus according to claim 8 wherein said lid is biased by a weight.

13. The apparatus according to claim 9 wherein said spring is positioned above said lid and biased against a head on said post distal to the flame arrestor.

14. The apparatus according to claim 8 wherein said spring is positioned below said lid, said spring being biased against a head attached to said post below said flame arrestor.

15 The apparatus according to claim 10 wherein said weight is above and seated on said lid.

16. The apparatus according to claim 10 wherein said weight is attached o said post below said flame arrestor.

17. The apparatus according to claim 1 wherein said flame arrestor is a metal honeycomb structure.

18. The apparatus according to claim 1 wherein said flame arrestor is a ceramic honeycomb.
